(19) United States
(12) Patent Application Publication
(10) Pub. No.: US 2007/0271812 A1
(43) Pub. Date: Nov. 29, 2007

(54) Device for Hardening the Coating of an Object, Consisting of a Material That Hardens Under Electromagnetic Radiation, More Particularly an Uv Paint or a Thermally Hardening Paint

(76) Inventors: Werner Swoboda, Boeblingen (DE); Werner Schuster, Ostelsheim (DE)

Correspondence Address: FACTOR & LAKE, LTD, 1327 W. WASHINGTON BLVD., SUITE 5G/H, CHICAGO, IL, 60607, US

(21) Appl. No.: 10/565,754

(22) PCT Filed: Jul. 10, 2004
(86) PCT No.: PCT/EP04/07644

§ 371 Date: Feb. 5, 2007

(30) Foreign Application Priority Data
Jul. 24, 2003 (DE) 103 35 006.3
May 13, 2004 (DE) 10 2004 023 537.6

(51) Int. Cl. F26B 15/16; F26B 3/347

(52) U.S. Cl. 34/266; 34/275; 34/666; 34/72

(57) ABSTRACT

The invention relates to a device for hardening a coating of an object, more particularly a car body (12), said coating consisting of UV paint, a thermally hardening paint or the like. The device comprises at least one radiator (58, 60a, 60b, 62a, 62b) producing electromagnetic radiation. A conveyor system (14, 16, 46) that moves the object (12) to the proximity of the radiator (58, 60a, 60b, 62a, 62b) and moves it away from said radiator is also provided. The conveyor system (14, 16) comprises a lifting car (46; 461) with a running gear (50) having a lift platform (54) for receiving the object (12), whose height relative to the running gear (50) can be adjusted by means of a motor. The at least one radiator (58, 60a, 60b, 62a, 62b) is arranged in such a manner that the lifting car (46; 461) and the object (12) located thereon can be guided through under the at least one radiator (58, 60a, 60b, 62a, 62b), wherein the vertical position of the object (12) can be changed. This makes it possible to also place objects (12) with very uneven and three-dimensionally curved surfaces in the irradiation area of the radiator (58, 60a, 60b, 62a, 62b) in such a way that the surfaces are evenly exposed to the amount and intensity of radiation required for hardening.

The invention relates to an apparatus for hardening a coating of an object, more particularly a vehicle body, said coating consisting of a material that hardens under electromagnetic radiation, more particularly a UV paint or a thermally hardening paint, having
a) at least one radiator producing electromagnetic radiation;
b) a conveying system that moves the object to the proximity of the radiator and moves it away from said radiator again.

Paints which harden under UV light have previously been employed mainly for painting sensitive objects, for example wood or plastic. In this case, the particular advantage of these paints is that they can be polymerised at very low temperatures. As a result, the material of the objects is protected from decomposition or outgassing. The hardening of coating materials under UV light has still further advantages, however, which now make this coating method interesting for use in other areas as well. These are in particular the short hardening time which directly results in a shortening of the installation length, particularly for coating methods which operate with continuous pass-through. This is associated with enormous cost savings. At the same time, the device with which the gases to be introduced into the interior space of the apparatus are conditioned can be reduced in size, which likewise contributes to cost savings. Finally, the low operating temperature is also advantageous for objects which could actually bear higher hardening temperatures, since this saves energy, particularly thermal energy.

Many of the objects which one would like to coat with UV-hardening materials, for instance vehicle bodies, have a very uneven, often three-dimensionally curved surface, so that it is difficult to bring these objects into the radiation area of a UV radiator in such a way that all the surface regions are at approximately the same distance form the UV radiator and the UV radiation strikes the particular surface region of the object approximately at a right angle.

Known apparatuses of the type mentioned at the outset, as previously employed in the wood and plastics industry, are unsuitable for this, since here the UV radiator(s) were arranged immovably and the objects were guided past the UV radiator(s) by the conveying system in a more or less fixed orientation.

Recently, paints have additionally been developed which harden under the effect of heat in an inert gas atmosphere to form very hard surfaces. The heat can be supplied here in various ways, such as by convection or by infrared radiators. In the latter case, similar problems to those described above for the use of UV radiators arise. In particular, all the surface regions of the object to be painted should therefore be guided past the infrared radiator at approximately the same distance.

The object of the present invention is to configure an apparatus of the type mentioned at the outset such that coatings on very uneven objects of complicated shape, in particular vehicle bodies, can also be hardened with a good result.

This object is achieved according to the invention in that the conveying system comprises a lifting truck with a running gear, said lifting truck having a lifting platform for receiving the object, the height of which lifting platform relative to the running gear can be adjusted by means of a motor, and in that the at least one radiator is arranged in such a manner that the lifting truck and the object located thereon can be guided through under the at least one radiator.

The invention is based on the finding that such a lifting truck having a height-adjustable lifting platform enables in a very simple manner a movement in the vertical direction to be combined with a translatory movement in the horizontal direction. This makes it possible to guide the object on the lifting truck through under the at least one radiator and in the process change the height of the lifting platform such that the object placed thereon is evenly exposed at all the surface regions to an amount of radiation and intensity of radiation as are required for hardening the material. This is because complete hardening only occurs when the electromagnetic radiation, on the one hand, strikes the coating with an intensity lying above a threshold value and, on the other hand, this intensity is also maintained over a specified period of time. If the intensity is too low, a polymerisation reaction does not start or does not proceed to completion; if the irradiation is too short—even with sufficient intensity—again only incomplete hardening is achieved.

Such a lifting truck is even more versatile if, according to a particularly preferred configuration of the invention, the lifting platform is tiltable relative to the running gear by means of a motor. The tilting can take place here about a transverse axis of the lifting truck, a longitudinal axis of the lifting truck or about both said axes combined.

Tiltability about a transverse axis enables a translatory movement in the horizontal direction to be optionally dispensed with, since the object can now be oriented, in many cases even with respect to a plurality of radiators arranged in a plane or to one large planar radiator, such that setback regions of the upward-facing surface of the object are still exposed to the electromagnetic radiation to a sufficient extent.

Tiltability about a longitudinal axis of the lifting truck is particularly advantageous when lateral radiators are provided as well and the object has a curved or otherwise very uneven contour at its lateral surfaces as well.

Tiltability about a tilting axis can be realised, for example, by the lifting platform comprising two supporting plates which are separated from one another by at least one length-variable ram. This ram can comprise, for example, hydraulically actuably telescopic cylinders. Tiltability about two tilting axes requires at least two rams.

Particularly preferred is, furthermore, an embodiment of the invention in which the apparatus has a container with an opening, through which the object can be guided into the container by height adjustment of the lifting platform, the interior space of the container being able to be subjected to electromagnetic radiation by at least one radiator. This container ensures that no electromagnetic radiation and no gases can escape in the lateral direction, which is to be avoided on grounds of the health of the operating personnel. The container can be constructed here as an independent part, as a channel or else as an appropriately lined floor region or roof region of a booth housing or the like.

The arrangement of the radiators on or in the container can vary:

For instance, it is possible for at least one radiator to be fitted in a wall, a ceiling or a floor of the container. In the case of three-dimensionally curved surfaces of objects to be treated, the preferred solution here is that in which at least one radiator is fitted in the opposite side walls running parallel to the translatory movement of the objects and in at least one of the two end walls running perpendicular to the translatory movement of the objects and also in a ceiling or a floor of the container. In this case, all the sides or surface regions of the object can be reached by electromagnetic radiation without problems.

The most versatile is, of course, that embodiment of the invention in which a multiplicity of radiators are arranged on all walls and in a ceiling or a floor of the container.

In the above embodiments, in which the radiators are arranged in the walls or in a ceiling of the container, the radiators form essentially planar radiators.

It is, however, also possible advantageously to use radiators which are configured as linear radiators. In this case, an advantageous embodiment of the invention is in particular one in which a plurality of radiators are arranged on a bridge-like portal frame which has two substantially vertical legs and a substantially horizontal base. The object to be treated is so to speak “threaded through” between the vertical legs of the portal frame here.

The arrangement of the radiators on the substantially vertical legs of the portal frame can be adapted to the course of the lateral surfaces of the object. It is thus possible, even if the object has a curved lateral contour, to achieve uniform and complete hardening of the coating on the lateral surfaces of the object.

If the upward-facing surface of the object is greatly curved, it may be advantageous to adapt the arrangement of the radiators on the substantially horizontal base to the course of the upward-facing surface of the object. Such a segmental arrangement of the radiators on the horizontal base makes it possible to guide the object past the arrangement of the radiators such that the distance of the latter from the upward-facing surface of the object remains largely constant.

Particularly preferably, a protective gas can be supplied to the interior space of the container. The protective gas has primarily the function of preventing the presence of oxygen in the radiation area of the radiators, since oxygen can be converted into harmful ozone particularly under the influence of UV light and, moreover, impairs the progress of the polymerisation reaction.

In the case of a container with an upwardly or laterally facing opening for introducing the object, it is particularly favourable for the protective gas to be heavier than air. Carbon dioxide, for example, is suitable for this.

In the case of a container with a downward-facing opening for introducing the object, it is particularly favourable for the protective gas to be lighter than air. Helium, for example, is suitable for this.

If there is an inlet for the protective gas in the immediate vicinity of the at least one radiator, said gas can be utilised at the same time as a cooling gas for the radiators. Alternatively or additionally to this, however, at least one inlet can also be oriented such that the protective gas emanating from the inlet is directed directly at the surface currently being irradiated. This ensures that the proportion of undesired foreign gases at the reaction site at which the electromagnetic radiation produces the hardening is very low.

If at least one radiator is assigned a movable reflector on the side facing away from the object, an additional adaptation of the direction of radiation to the course of the surface of the object to be treated is possible.

The container can be at least partly lined with a reflective layer. As a result, radiators with lower power can be employed.

It is particularly favourable in this case if the layer is uneven. The reflections take place at different angles under these circumstances, so that the interior space of the container is very uniformly filled with electromagnetic radiation of greatly varying propagation directions.

A suitable layer material is, for example, an aluminium foil, since this has a very good reflectivity for electromagnetic radiation and, in addition, is inexpensive. Furthermore, an uneven layer can be realised in a simple manner therewith, namely by crumpling the aluminium foil.

The apparatus according to the invention should have a booth housing which prevents uncontrolled escape of gases and electromagnetic radiation. Both would endanger the health of the operating personnel.

A lock for the lifting truck can be respectively provided at the inlet and at the outlet of the booth housing. These locks prevent any great amounts of air from the outside atmosphere from getting into the booth housing upon the entry and exit of the transporting truck into or from the booth housing. In addition, the locks protect operating persons from harmful electromagnetic radiation.

In the case of objects with hollow spaces, it may additionally be expedient to arrange a further inlet for protective gas within the inlet-side lock in such a way that the hollow spaces are flushed with protective gas, whereby air contained therein is displaced.

Since, however, the ingress of air, in particular oxygen, into the interior of the booth housing cannot be completely suppressed even with locks, a device for removing oxygen from the atmosphere situated within the booth housing is expediently provided. This device can comprise a catalyst for catalytically binding the oxygen, a filter for absorbing or else a filter for adsorbing oxygen.

If the coating material initially still contains a relatively large amount of solvent, as is the case, for example, with water-based paints, the apparatus for removing the solvent from the material of the coating can have a preheating zone. If, in contrast, pulverulent materials are to be processed, the apparatus can have an appropriate preheating zone for partial gelling of this pulverulent material.

Furthermore, provision may be made for the apparatus to have a post-heating zone for completing the hardening. The hardening reaction initiated by the electromagnetic radiation can in this case continue in the post-heating zone until the coating is completely hardened.

In principle, manual control of the lifting truck is also possible, if an operating person can visually monitor the irradiating operation and controls the appropriate lifting and optionally tilting movements of the lifting platform in dependence on the outer contour of the irradiated object. Preferably, however, the apparatus has a control system which automatically controls the height of the lifting platform in dependence on the upward-facing outer contour of the object.

The height of the lifting platform can be changeable by the control system in such a way that, during a translatory movement of the object past the at least one radiator, the distance in the vertical direction between the object and the at least one radiator remains at least approximately constant. This ensures that all the upward-facing surface regions of the object are exposed to the same intensity of radiation and approximately the same amount of radiation, i.e. the same irradiation in the photometric sense.

The three-dimensional shape data of the object required for such a control system can be provided by a higher-level data processing system. The apparatus can, however, acquire these three-dimensional shape data itself. To that end, a measuring station which is arranged upstream of the at least one radiator in the conveying direction and by which three-dimensional shape data of the object can be acquired is to be provided.

In a particularly simple design, the measuring station comprises merely one or more light barriers, which are preferably arranged in the immediate vicinity of the at least one radiator and cooperate with the control system. If the object to be irradiated breaks a light barrier, an appropriate evading movement of the object is brought about in real time.

A more precise detection of the three-dimensional shape is possible if the measuring station has at least one optical scanner which can contain, for example, an infrared light source, by which the object can be scanned in at least one direction. Another possibility of precisely detecting the three-dimensional shape is afforded by digital image processing and recognition of video images of the object. The measuring station then has a video camera and a device for digital image recognition.

Particularly in the case of embodiments in which the object on the lifting truck is guided through under a portal frame, the lifting truck must also perform a translatory movement. Since the coating on the object must not be exposed too briefly to the electromagnetic radiation, this translatory movement cannot be performed at an arbitrary speed. If a lifting truck is guided slowly through the portal frame and, after transferring the object to a conveying system, then moved back empty to its starting location again, this operation takes a not inconsiderable length of time.

It is advantageous, therefore, if the conveying system comprises specifically a lifting truck and a travelling path for the lifting truck, along which path the at least one radiator is arranged, a receiving station for receiving the object on the lifting platform and a delivery station for delivering the object spatially coinciding. Such an arrangement leads to the lifting truck with the object placed thereon travelling twice past the at least one radiator, namely once in the forward direction and once in the reverse direction, and thereby returning to its starting point again. There, the object can be removed from the lifting platform, which is then free to receive a new object to be irradiated. The speed of travel past the at least one radiator can be approximately doubled with this configuration of the invention, since all the surface regions are exposed twice to the electromagnetic radiation. This configuration of the invention requires relatively few installation components.

A higher throughput can be achieved if the conveying system comprises at least two lifting trucks, in which case, between a receiving station for receiving the object on the lifting platform and a delivery station for delivering the object, two travelling paths for the lifting trucks extend in such a way that the lifting trucks can circulate in a closed circuit between the receiving station and the delivery station.

The electromagnetic radiation is preferably UV light or infrared radiation.

Further features and advantages of the invention emerge from the following description of the exemplary embodiments with reference to the drawing, in which:

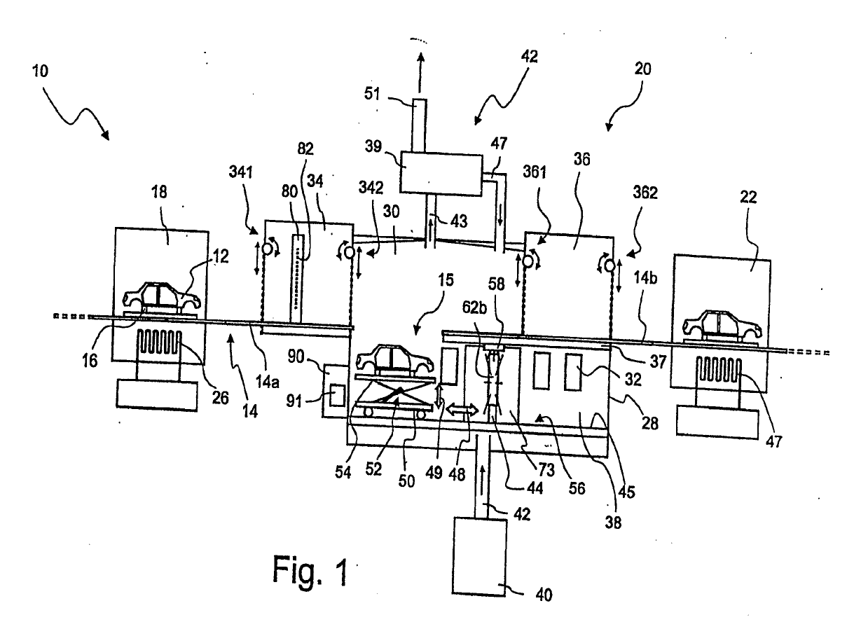

FIG. 1 shows an apparatus for hardening UV paints in a greatly simplified longitudinal section which is not to scale;

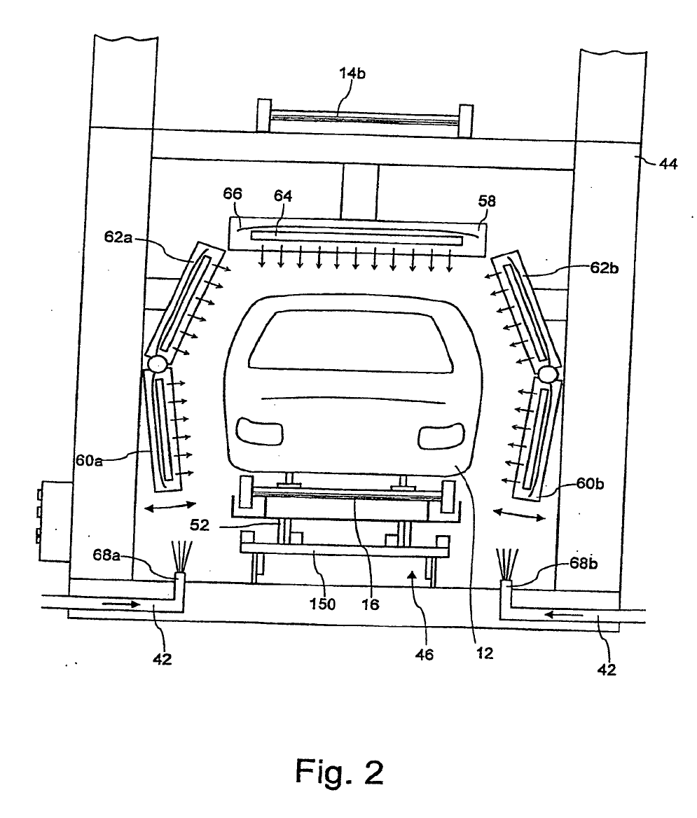

FIG. 2 shows a front view of a portal frame with a lifting truck travelling through, the lifting truck carrying a motor-vehicle body;

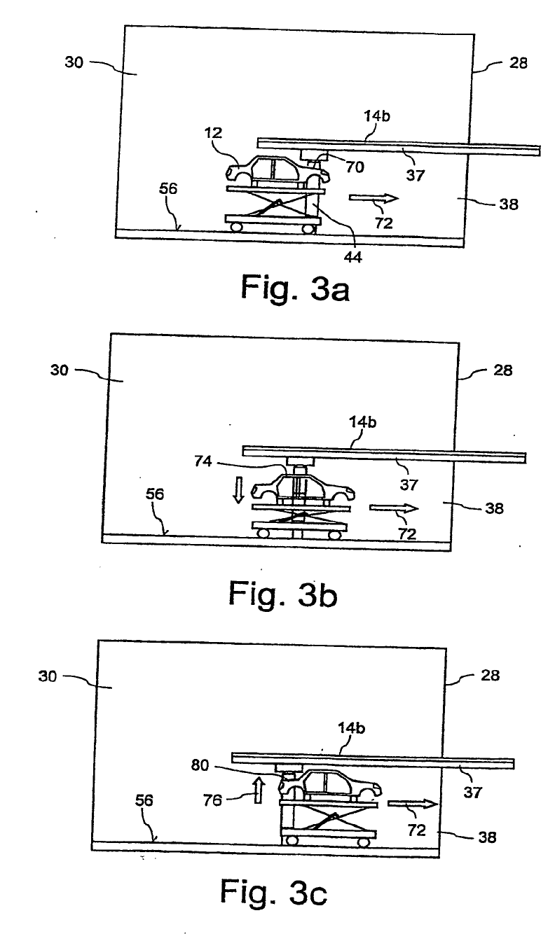

FIGS. 3a to 3c show a detail from FIG. 1 for different phases as the lifting truck is travelling through the portal frame;

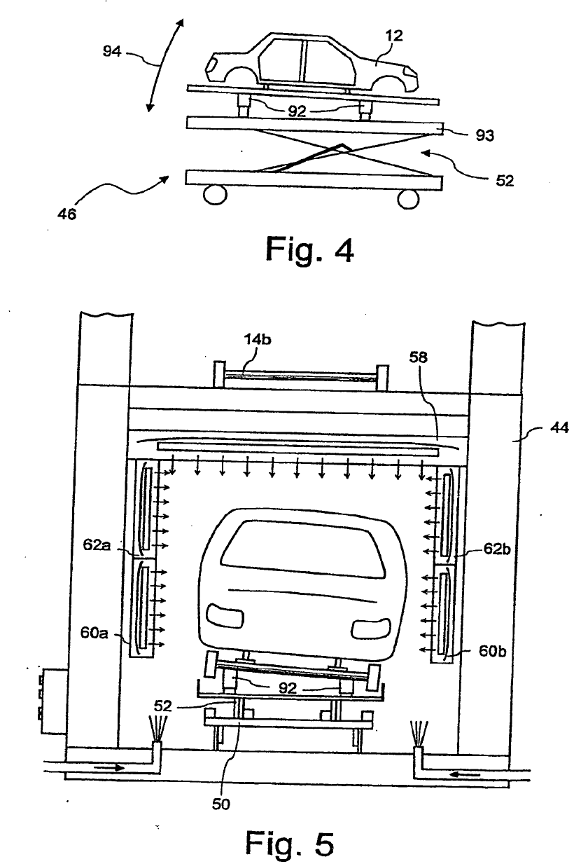

FIG. 4 shows a lifting truck, in the case of which a vehicle body placed thereon can be tilted in a transverse direction;

FIG. 5 shows an illustration corresponding to FIG. 2, in the case of which a vehicle body carried by the lifting truck is tilted about a longitudinal axis;

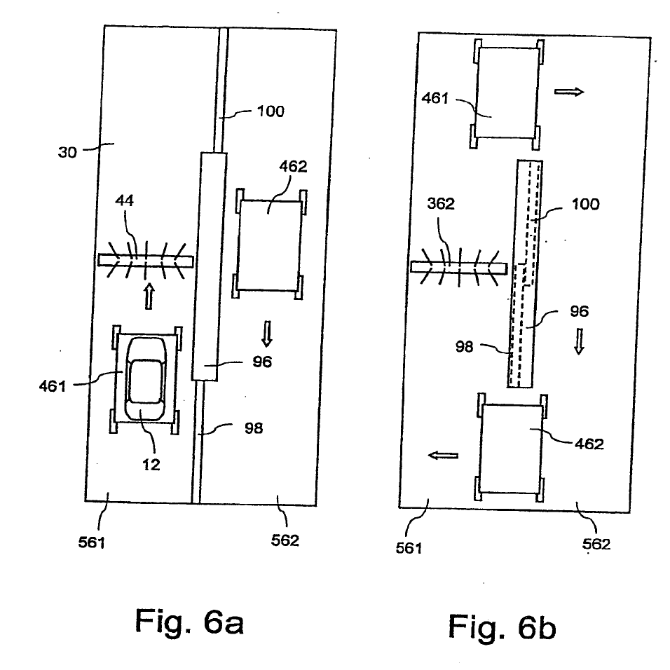

FIGS. 6a and 6b show greatly simplified plan views of an interior space of a booth housing according to another exemplary embodiment at two different times.

In FIG. 1 an apparatus for hardening UV paints is shown in a greatly simplified longitudinal section which is not to scale, and is denoted as a whole by 10. The hardening apparatus 10 illustrated by way of example is part of a painting installation which is provided for applying a multilayer paint coating to preassembled vehicle bodies 12.

The hardening apparatus 10 comprises a roller-path conveying system for the vehicle bodies 12, which is known per se and comprises a roller path 14, which is subdivided by an opening 15, still to be described, into two subsegments 14a and 14b, and supports 16 resting thereon for the motor-vehicle bodies 12. Supports of this type, also referred to a skid supports, have skid-like slides, by which they rest on the roller path 14. Since such a roller-path conveying system is known per se in the prior art, it will not be described in further detail.

With the aid of the roller-path conveying system extending beyond the hardening apparatus 10, the vehicle bodies 12 can be supplied to the hardening apparatus 10 and transported between the individual stations of the hardening apparatus 10. These stations are a preheating zone 18, an irradiating apparatus 20 and a post-heating zone 22.

The preheating zone 18 and the post-heating zone 22 each contain heating devices, which are indicated by 24 and 26, respectively, and are designed as hot-air heaters.

Alternatively, heating by IR radiators or with the aid of a magnetron for generating microwaves is possible. The preheating zone 18 can perform different functions depending on the type of coating material. If this material comprises solvent-based substances, for example is a water-based paint, the solvents are as far as possible removed here. If it is a powder material, the preheating zone 18 serves for partial gelling of the powder and thus preparing it for polymerisation.

The irradiating apparatus 20 comprises a booth housing 28, which is designed such that neither a gas exchange with the surroundings nor escape of UV light is possible. In order to be able to observe the operations in an interior space 30 of the booth housing 28 from outside, windows 32 which are pervious to visible light but impervious to UV light are let into the outer walls of the booth housing 28.

In order to prevent an exchange of gases with the surroundings and to protect the operating personnel from UV light, the irradiating apparatus 20 furthermore has an inlet lock 34 and an outlet lock 36, through which the supports 16 with the vehicle bodies 12 fastened thereon have to pass on travelling into the interior space 30 and on travelling out of it. The inlet lock 34 and the outlet lock 36 are each constructed, in the exemplary embodiment illustrated, as double locks with two movable roll-up gates 341, 342 and 361, 362, respectively.

A ceiling 37 is fitted in the interior space 30 of the booth housing 28 in such a way that the part of the interior space 30 lying beneath it forms a type of container 38. The ceiling 37 contains the opening 15 already mentioned above, via which the roller path 14 is interrupted. As an alternative to this configuration, provision may also be made for the ceiling 37 to be dispensed with and instead of this for a separate container, constructed as a trough, to be placed in the then free interior space 30, over which container part of a roller path 14 extends.

Irrespective of the type of its design, the container 38 can be filled with a protective gas, which is stored in a gas container 40 and can be led in via a line 42 opening into the bottom of the container 38. In the exemplary embodiment illustrated, the protective gas is carbon dioxide, since this is heavier in the gaseous state than air and thus fills the upwardly open container 38 in a similar manner to a liquid. The amount of protective gas supplied via the line 42 is in dynamic equilibrium with the amount of protective gas which escapes, inter alia, via the inlet and outlet locks 34 and 36, respectively.

Furthermore, the interior space 30 is connected to a regeneration circuit 42, the purpose of which is to remove oxygen, which is brought into the interior space 30 via the vehicle bodies 12 or gets in when the inlet lock 34 or the outlet lock 36 is opened, from the atmosphere prevailing in the interior space 30. To that end, gas is continuously withdrawn from the interior space 30 via a line 43 and routed, for example, via a catalyst 39 which catalytically binds the oxygen. Part of this gas is returned via the line 47 to the interior space 30 of the booth housing 28, while another part is released to the outside atmosphere via a line 51.

A lifting truck, denoted as a whole by 46, is placed on a floor surface 45 of the container 38 and is capable of translatory movement in a direction indicated by a double arrow 48, for which a drive, arranged on the lifting truck 46 and not illustrated specifically in FIG. 1, is used. The lifting truck 46 has a running gear 50 and a lifting device 52, as is known per se in the prior art and which can be designed, for example, as a hydraulically or electrically driven scissors-type drive. The upward-facing plane of the lifting device 52, which serves for receiving supports 16, forms a lifting platform 54. In the case of a lifting device 52 constructed as a scissors-type drive, this lifting platform 54 can also comprise a frame which movably connects the scissor limbs; the term “platform” does not therefore necessarily have to imply a continuous surface. With the aid of the lifting device 52, the lifting platform 54 can be moved vertically in the direction indicated by a double arrow 49.

Also arranged in the container 38 is a portal frame 44, the details of which are explained below with reference to FIG. 2.

In FIG. 2 the portal frame 44 is shown in a front view in an enlarged illustration. The portal frame 44 spans, in the manner of a bridge, a travelling path 56, provided for the travelling of the lifting truck 46, on the floor surface 45 of the interior space 30. Fastened to the portal frame 44 are a UV-light-generating roof radiator 58, a pair of lower UV-light-generating side radiators 60a, 60b arranged on both sides of the travelling path 56, and a pair of upper UV-light-generating side radiators 62a, 62b arranged on both sides of the travelling path 56. The roof radiator 58 and the four side radiators 60a, 60b, 62a, 62b each contain, as denoted specifically by reference numbers for the roof radiator 58, a bar-shaped light source 64. Each UV radiator is additionally assigned a reflector 66. The bar-shaped light source 64 can also be replaced here by a multiplicity of approximately point-shaped individual light sources.

The UV radiators 58, 60a, 60b, 62a and 62b are fastened to the portal frame 44 such that their arrangement corresponds approximately to the outer contour of the vehicle body 12. In the exemplary embodiment illustrated, the two lower side radiators 60a, 60b are articulated in a manner adjustable by motor on the two upper side radiators 62a and 62b, respectively, with the result that these lower side radiators 60a, 60b can be automatically adapted to the shape of the lower half of the vehicle body 12 while the latter is travelling through the portal frame 44 on the lifting truck 46.

To harden UV paint which is situated on inner surfaces of the vehicle body 12 and cannot be reached from outside by the UV radiators 58, 60a, 60b, 62a, 62b, use may be made of an additional UV radiator which is held by a movable robot arm (not illustrated) insertable into the interior space of the vehicle body 12.

Let into the region of the floor surface 45 below the portal frame 44 are outlet nozzles 68a, 68b which are connected to the line 42 and from which carbon dioxide as the protective gas can be blown into the gap between the UV radiators 58, 60a, 60b, 62a, 62b and the vehicle body 12 during operation. This protective gas serves, on the one hand, for cooling the UV radiators 58, 60a, 60b, 62a, 62b and displaces, on the other hand, undesired oxygen-containing residual gases, which can lead to the formation of ozone under the influence of UV light and impair the polymerisation reaction.

In the immediate vicinity of the portal frame 44, the container 38 is lined with a crumpled aluminium foil 73 in order to achieve a high degree of light reflection.

The above-described hardening apparatus 10 works as follows:

It is assumed that a plurality of paint coats have already been applied in an upstream coating facility of the painting installation. The uppermost paint coat is a clear coat, which is applied as a powder to the paint coats already present. Under the influence of UV light, the clear coat polymerises and thus hardens. A prerequisite for this is firstly that the powder paint is previously converted into a quasi-liquid, gel-like state. The preheating zone 18, in which a vehicle body 12 brought into this zone is heated to a temperature of about 90°, serves this purpose. At this softening temperature, the powder changes into the aforementioned gel-like state.

From the preheating zone 18, the support 16 with the vehicle body 12 placed thereon is moved on the roller path 14 to the inlet lock 34. In parallel with this, the unloaded lifting truck 46 is brought into the position shown in FIG. 1 and the lifting platform 54 is raised until it is situated at the level of the roller path 14. Then, the support 16 with the vehicle body 12 passes through the two roll-up gates 341, 342 of the inlet lock 34 one after the other and thus arrives in the interior space 30 of the booth housing 28. There, the support 16 is taken over by the waiting lifting platform 54 of the lifting truck 46.

Subsequently, the lifting platform 54 is lowered with the aid of the lifting device 52 to such an extent that the lifting truck 46 with the vehicle body 12 now arranged thereon can travel along below the ceiling 37. The vehicle body 12 is in this case situated completely within the protective gas atmosphere prevailing in the container 38.

The further procedure is outlined below with reference to FIGS. 3a to 3c. These figures each show, in an illustration based on FIG. 1, the interior space 30 of the booth housing 28 with the container 38, the portal frame 44 and the lifting truck 46.

In the position of the lifting truck shown in FIG. 3a, the lifting platform 54 is still raised to such an extent that a front gate 70 of the vehicle body 12 is spaced at a set distance, optimal for hardening, of for example about 30 cm from the roof radiator 58, while the lifting truck 46 is moving on the travelling path 56 in the direction indicated by an arrow 72. In the course of the further forward movement of the lifting truck 46, the lifting platform 54 is lowered to such an extent that the roof 74 of the vehicle body 12 is now at the set distance from the roof radiator 58. This state is shown in FIG. 3b.

After a further forward movement along the arrow 72, the lifting platform 54 is raised again, as indicated by an arrow 76. As a result, the rear gate 80 can now also be guided past at the set distance below the roof radiator 58. When the lifting truck 46 has passed through the portal frame 44 once in the above-described manner, the movement direction of the lifting truck 46 is

The procedure shown with reference to FIGS. 3a to 3c is then repeated in reverse order. In this way, every part of the surfaces of the vehicle body 12 facing to the sides and upwards is exposed twice to irradiation with UV light.

After the lifting truck 46 has reached its starting position shown in FIG. 1 again, the lifting platform 54 is raised with the aid of the lifting device 52 to such an extent that the support 16 with the vehicle body 12 carried thereby can be moved onto the subsegment 14b, shown on the right in FIG. 1, of the roller path 14. The support 16 with the vehicle body 12 then passes through the outlet lock 36 and leaves the irradiating apparatus 20.

Finally, the support 16 with the vehicle body 12 is also supplied to the post-heating zone 22, in which a temperature of about 105° prevails. The vehicle body 12 stays there for about five to ten minutes, during which the polymerisation reaction is completed. This time may vary greatly depending on the coating material.

To control these operations, a central control system 90 is provided. Its job is in particular to control the movements of the lifting truck 46 in the horizontal direction (double arrow 48) and also perpendicularly thereto in the vertical direction (double arrow 49). To that end, the control system 90 has a memory 91, in which three-dimensional shape data of the vehicle body 12 are stored. These three-dimensional shape data can be retrieved, for example, by a higher-level data processing system, in which data relevant to all vehicle bodies 12 passing through the hardening apparatus 10, such as the type and colour of the paint coating and the body type and shape, are stored. All that is then required is a sensing device which detects the type of vehicle body 12 arriving, so that the three-dimensional shape data assigned to this type can be retrieved.

As an alternative or, for checking purposes, in addition to this, it is possible to ascertain the required three-dimensional shape data also with a measuring device 80 which is arranged within the inlet lock 34 (see FIG. 1). The measuring device 80 has a U-shaped frame, to which a multiplicity of optical scanners 82 with infrared light sources are fastened in the vertical direction 49. The optical scanners 82 scan the outer contour of the vehicle body 12 as it passes through the measuring device 80.

If the requirements with regard to accuracy are not as stringent, however, it may also be sufficient to design the measuring device as a simple light-barrier arrangement which is arranged in the immediate vicinity of the portal frame 44. The breaking of a light barrier then indicates to the control system 90 that the vehicle body 12 is approaching the roof radiator 58 to such an extent that the lifting platform 54 has to be lowered.

Such a control system results in a lifting and lowering movement of the lifting platform 54 taking place in a stepped manner, since the light barriers do not allow continuous monitoring of the outer contour.

FIG. 4 shows a lifting truck 46′, in the case of which four rams 92 forming a rectangular arrangement are arranged on a support plate 93 which forms a first plane and is placed on the lifting device 52. The rams 92 are capable of telescoping hydraulically and can be extended independently of one another. The upper ends of the rams 92, which form a second plane 95, bear the support 16. In this way, it is possible to tilt the support 16 with the vehicle body 12 placed thereon both about a transverse axis, as indicated by a double arrow 94 in FIG. 4, and about a longitudinal axis of the lifting truck 46.

Such a tilting about a longitudinal axis is shown in FIG. 5, which corresponds largely to FIG. 2. Unlike the latter, however, the side radiators 60a, 60b and 62a, 62b are vertically aligned. Uniform irradiation of the lateral surfaces of the vehicle body 12 is obtained here by tilting the latter about its longitudinal axis.

FIGS. 6a and 6b show, in a plan view, the interior space 30 according to another exemplary embodiment of the invention, in which two lifting trucks 461, 462 transport vehicle bodies 12 through the portal frame 44 in a circulating operation. It is also possible for more than two lifting trucks to be moved through the installation, so that the vehicles are transported through the portal frame and irradiated at short intervals. In this exemplary embodiment, furthermore, two travelling paths 561, 562 separated from one another by a partition wall 96 are provided. A connection can be made between the two travelling paths 561 and 562 in the region of the two end sides of the interior space 30 by retracting sliding doors 98, 100 into the partition wall 96, as shown in FIG. 6b.

The circulating operation of the two lifting trucks 461 and 462 here proceeds as follows:

While a vehicle body 12 is being moved on the first lifting truck 461 through the portal frame 44 and exposed to the UV light in the process, the second lifting truck 462 is situated on the adjacent travelling path 562 on the return path. When the first lifting truck 461 with the vehicle body 12 has passed through the portal frame 44 and transferred the irradiated vehicle body 12 at the end of the travelling path 561, the sliding door 100 is opened, so that the lifting truck 461 can be moved laterally onto the adjacent travelling path 562. Simultaneously, the empty lifting truck 462 travels in an opposite movement through the sliding door 98, which is now open as well, from the second travelling path 562 second lifting truck 462 can be loaded with a vehicle body 12 to be irradiated.

The above exemplary embodiments are used to harden paints under UV light. However, they can also be used with paints which harden under the effect of heat, in particular in an inert gas atmosphere, that is to say, for example, in a CO₂ or nitrogen atmosphere. All that is then required is essentially to replace the UV radiators described by IR radiators. Other constructional adaptations associated with the change of electromagnetic radiation are known to a person skilled in the art and do not need further explanation here.

1. An apparatus for hardening a coating of an object, said coating including a material that hardens under electromagnetic radiation, the apparatus including
at least one radiator producing electromagnetic radiation; and,
a conveying system that moves the object to the proximity of the radiator and moves it away from said radiator again;
wherein
the conveying system comprising: a lifting truck with a running gear, said lifting truck having a lifting platform for receiving the object, the height of which lifting platform relative to the running gear can be adjusted by means of a motor, and in that the at least one radiator is arranged in such a manner that the lifting truck and the object located thereon can be guided through under the at least one UV radiator.

2. Apparatus according to claim 1, wherein the lifting platform is tiltable relative to the running gear by means of a motor.

3. Apparatus according to claim 2, wherein the lifting platform comprises two planes which are separated from one another by at least one length-variable ram.

4. Apparatus according to claim 1, further comprising a container with an opening, through which the object can be guided into the container by height adjustment of the lifting platform, and in that the interior space of the container can be subjected to electromagnetic radiation by at least one radiator.

5. Apparatus according to claim 4, wherein at least one radiator is fitted in a wall, a ceiling or a floor of the container.

6. Apparatus according to claim 5, wherein at least one radiator is fitted in the opposite side walls running parallel to the translatory movement of the objects and in at least one of the two end walls running perpendicular to the translatory movement of the objects or in a ceiling or a floor of the container.

7. Apparatus according to claim 5, wherein a multiplicity of radiators are arranged on all walls and in a ceiling or a floor of the container.

8. Apparatus according to claim 1 wherein a plurality of radiators are arranged on a bridge-like portal frame which has two substantially vertical legs and a substantially horizontal base.

9. Apparatus according to claim 8, wherein the arrangement of the radiators on the substantially vertical legs of the portal frame is adapted to the course of the lateral surfaces of the object.

10. Apparatus according to claim 7, wherein the arrangement of the radiators on the substantially horizontal base is adapted to the course of the upward-facing surface of the object.

11. Apparatus according to claim 4, wherein a protective gas can be supplied to the interior space of the container.

12. Apparatus according to claim 11, wherein the protective gas is heavier than air.

13. Apparatus according to claim 11, wherein the protective gas is lighter than air.

14. Apparatus according to claim 12, wherein there is an inlet for the protective gas in the immediate vicinity of the at least one radiator.

15. Apparatus according to claim 1, wherein at least one radiator is assigned a movable reflector on the side facing away from the object.

16. Apparatus according to claim 4, wherein the container is at least partly lined with a reflective layer.

17. Apparatus according to claim 16, wherein the layer is uneven.

18. Apparatus according to claim 16, wherein the layer consists of an aluminium foil.

19. Apparatus according to claim 1, further comprising a booth housing which prevents uncontrolled escape of gases and electromagnetic radiation.

20. Apparatus according to claim 19, wherein a lock for the object is respectively provided at the inlet and at the outlet of the booth housing.

21. Apparatus according to claim 20, wherein an inlet for protective gas is arranged within the inlet-side lock in such a way that a hollow space present in the object is flushed with a protective gas.

22. Apparatus according to claim 20, wherein a device for removing oxygen from the atmosphere situated within the booth housing is provided.

23. Apparatus according to claim 22, wherein the device for removing oxygen has a catalyst for catalytically binding the oxygen.

24. Apparatus according to claim 22, wherein the device for removing oxygen has a filter for absorbing oxygen.

25. Apparatus according to claim 22, wherein the device for removing oxygen has a filter for adsorbing oxygen.

26. Apparatus according to claim 1, further comprising a preheating zone for removing the solvent from the material of the coating.

27. Apparatus according to claim 1 further comprising a preheating zone for partial gelling of pulverulent material.

28. Apparatus according to claim 1, further comprising a post-heating zone for completing the hardening.

29. Apparatus according to claim 1, further comprising a control system which controls the height of the lifting platform in dependence on the upward-facing outer contour of the object.

30. Apparatus according to claim 29, wherein the height of the lifting platform can be changed by the control system in such a way that, during a conveying movement of the object past the at least one radiator, the amount of electromagnetic radiation striking the material per unit area, and the intensity thereof, in each case does not fall below predeterminable threshold values required for hardening.

31. Apparatus according to claim 30, wherein the height of the lifting platform can be changed by the control system in such a way that, during a conveying movement of the object past the at least one radiator, the distance in the vertical direction between the object and the at least one radiator remains at least approximately constant.

32. Apparatus according to claim 30, wherein the control system comprises a memory for storing three-dimensional shape data of the object.

33. Apparatus according to claim 29, wherein the apparatus comprises a measuring station which is arranged upstream of the at least one radiator in the conveying direction and by which three-dimensional shape data of the object can be acquired.

34. Apparatus according to claim 33, wherein the measuring station comprises at least one light barrier.

35. Apparatus according to claim 33, wherein the measuring station comprises a video camera and a device for digital image recognition.

36. Apparatus according to claim 33, wherein the measuring station comprises at least one optical scanner, by which the object can be scanned at least in one direction.

37. Apparatus according to claim 36, wherein the optical scanner comprises an infrared light source.

38. Apparatus according to claim 1, wherein the conveying system comprises a lifting truck and a traveling path for the lifting truck, along which path the at least one radiator is arranged, and in that a receiving station for receiving the object on the lifting platform and a delivery station for delivering the object spatially coincide.

39. Apparatus according to claim 1, wherein the conveying system comprises at least two lifting trucks and in that, between a receiving station for receiving the object on the lifting platform and a delivery station for delivering the object, two traveling paths for the lifting trucks extend in such a way that the lifting trucks can circulate in a closed circuit between the receiving station and the delivery station.

40. Apparatus according to claim 1, wherein the electromagnetic radiation is UV light.

41. Apparatus according to claim 1, wherein the electromagnetic radiation is IR radiation.
